(19) United States
(12) Patent Application Publication
(10) Pub. No.: US 2004/0023692 A1
(43) Pub. Date: Feb. 5, 2004

(54) Microcellular RF transmission system with baseband signal delivery via a wireline connection

(75) Inventors: Paul Posner, San Antonio, TX (US); Stefan Scheinert, San Diego, CA (US)

Correspondence Address: PRIEST & GOLDSTEIN PLLC, 5015 SOUTHPARK DRIVE, SUITE 230, DURHAM, NC, 27713-7736, US

(73) Assignee: Allegheny Holdings I, LLC., Pittsburgh, PA (US)

(21) Appl. No.: 10/462,911

(22) Filed: Jun. 17, 2003

Related U.S. Application Data
(60) Provisional application No. 60/399,587, filed on Jul. 30, 2002.

(51) Int. Cl. H04B 1/00

(52) U.S. Cl. 455/561; 455/449; 455/41.2

(57) ABSTRACT

Techniques are described for splitting a base transceiver station into digital and rf functions. With relatively low cost simulcasting clusters of rf remotes located to define coverage areas and master base transceiver stations connected to the rf remotes by suitable wireline connectors, such as Ti lines, the bulk of the digital functions can be located anywhere that is desired. Numerous, small, low cost, low power rf remotes may be advantageously mounted on existing structures such as light poles, telephone poles, and the like to achieve desired areas of coverage cost effectively and with a high degree of flexibility with respect to meeting future increases in need for additional capacity.

### RELATED APPLICATIONS

The present invention claims the benefit of U.S. Provisional Application Serial No. 60/399,587 entitled “Microcellular RF Transmission With Baseband Signal Delivery Via a Wireline Connection” and filed Jul. 30, 2002.

### FIELD OF THE INVENTION

The present invention relates generally to improvements to wireless communication networks, and more particularly to advantageous techniques for radio frequency (rf) transmission in a microcellular environment. To this end, a plurality of low cost base remotes or radio frequency (rf) heads are connected by a wireline to an improved master base transceiver station located remotely from the rf heads to provide a flexible, cost effective network with excellent service coverage as addressed in greater detail below.

### BACKGROUND OF THE INVENTION

In one conventional network, a conventional macrocell network 100 shown in FIG. 1, the wireless network 100 is connected to a local phone system network (PSTN) 50 to provide wireless customers with access to wired phone network customers. The network 100 includes a plurality of n mobile switching centers (MSCs) 120₁, 120₂ . . . 120ₙ connected to a large plurality of base transceiver stations (BTSs) such as BTSs 131₁, 131₂, 131₃, and 132. Each MSC has a number of base station controllers, such as base station controllers (BSCs) 125₁ and 125₂ shown for the MSC120₁ of FIG. 1. The BTSs 131₁, 131₂, 131₃, and 132 are connected to the BSCs by T₁ lines 127₁, 127₂ 127₃ and 128, respectively. The BSCs may control one or more base transceiver station. The exemplary BSC 125 controls BTS 131₁, BTS 131₂ and BTS 131₃ while the exemplary BSC 125₂ controls BTS 132₁. For the sake of ease of illustration, additional BSCs for MSCs 120₂ . . . 120ₙ are not shown and neither are the large number of additional BTSs controlled by these MSCs.

Although other mounting arrangements are known as will be addressed in greater detail below, a common arrangement for mounting BTSs like those in a typical macrocell network is to collocate them with a broadcast tower, such as towers 141₁, 141₂, 141₃ and 142₁, which are schematically illustrated in FIG. 1. A hallmark of this macrocell approach is that the entire base station and its tower are located at a central point with respect to an area where coverage is needed. These towers are typically tall and expensive. Additionally, it is becoming increasingly difficult to get regulatory or other government approval for such towers and transceivers in new locations where coverage is needed as networks seek to expand. “Not in my backyard” is a common expression applicable to the effort to locate such new towers.

As a result of such difficulties and the expense attendant in such mounting arrangements, a BTS may commonly broadcast at the maximum power allowable to cover the maximum area of coverage consistent with the network standards and any governing broadcast laws. Thus, the BTS of a macrocell network is typically a high power, large, high cost device and little consideration is given to stripping the cost of logic out of the units as there is little incentive to do so. Whether the BTS broadcasts at maximum power levels or lower levels, which is the case as capacity limitations require the nearby placement of additional high power cell sites, the high cost of a high power cell site is not reduced. Thus, over the course of time, high power transmitters that were already installed are being used to provide the equivalent of low power coverage.

A variety of approaches to providing more effective and lower cost network coverage have been put forward. Among these are the approaches described in U.S. Pat. Nos. 5,787,344 and 6,128,496 which are incorporated by reference herein in their entirety. One of the inventors of the present invention is also the inventor of the above patents. Briefly, these patents describe a technique in which a central base transceiver station is coupled to a base station controller. The central base transceiver station wirelessly communicates at a higher power level directly with mobiles in a larger zone of coverage. It also communicates via a directional radio link with a number of decentral transceiver stations for a plurality of lower power cells. The decentral transceiver stations in turn communicate directly with mobiles within their own smaller zones of coverage. Like the macrocell approach, the entirety of a central base transceiver station for the above described patented approach is located central to an area for which coverage is needed and both the central base transceiver station and the decentral transceiver stations include redundant digital logic circuitry driving up the cost of these units which are numerous in a large network.

### SUMMARY OF THE INVENTION

The present invention addresses problems such as those identified above in connection with the macrocell and previously patented approaches, as well as other problems which will be apparent both from the discussion which follows and to those of ordinary skill in the art in light of the present discussion. According to one aspect of the present invention, the bulk of the digital logic is stripped out of a base transceiver station resulting in a master base transceiver station (MBTS) without any rf components and with the bulk of the digital processing components, and a separate base station remote including the rf components. The MBTS preferably comprises a base station kernel and a base station mother, the details of which are addressed further below. The MBTS is located remote from a plurality of low cost base station remotes and is connected preferably through wirelines to these remotes. In a presently preferred embodiment, the remotes will be mounted on preexisiting telephone poles and will be connected to their MBTS by an existing telephone line, such as a leased T1 line. Alternatively, other broadband connections, such as DSL, cable modem, fiberlinks, or the like, may be employed. It will be recognized that where the phone lines are buried underground, it may be necessary to employ a different approach such as that of the above described patents to fill in the network's coverage. Each remote has a limited amount of digital logic circuitry which may vary depending upon the application. Digital signals are preferably transferred between the MBTS and the remotes.

In one embodiment, the encoding and decoding function logic is stripped out of the base station remotes and is included in the base station kernel. In this case, a baseband interface is employed with all encoding and decoding done in the MBTS and the modulation done in the remotes. In an alternative embodiment, if it is desired to present less of a load to the wireline connection between the base station mother and the remotes, then the encoding and decoding circuitry is also designed into the remotes. A further possible split of the functionality is to locate the encoding in the MBTS and the decoding in the remotes.

Among its several advantages, the above discussed approach and various aspects of the present invention allow the clustering of relatively low cost, low power remotes which are capable of communicating in a simulcast mode of operation and do not need to be located near the MBTS providing their signaling. Also, they do not need to be central to a large area of desired coverage. It will be recognized that additional network capacity can be added by reconfiguring the remotes into different cluster patterns. For example, if one imagines a network of 100 remotes arranged in 10 clusters of 10 remotes, with appropriate software and control logic, these same remotes can be rearranged to form 10 clusters of 9 remotes and 1 cluster of 10 remotes for a new total of 11 clusters. A cluster may be viewed as equivalent to a sector or cell in a traditional high power cell site arrangement. As the remotes can be mounted on existing telephone poles, other pole structures, billboards, rooftops, or other preexisting structures, any holes in the network or additional service areas can be relatively easily filled in or added, respectively. With respect to existing telephone poles, it is envisaged the remote can be physically mounted at or near the top of the pole, or an extension to the pole, such as a street light arm, and will also connect to its MBTS through a phone line carried by the pole. It is important to note that because of the wireline connection, the MBTS can be located wherever it is desired and independent of the placement of the remote units. It can and preferably will be located indoors where it is not susceptible to the ravages of, heat, cold, rain, snow, high wind and other weather conditions which may be faced by tower mounted base stations.

It will also be recognized that the present techniques may be readily adapted to various existing systems, such as 2G and 3G mobile networks like GSM, CDMA, WiFi, or UMTS, and the like, as well as further systems not yet on the drawing board.

Additionally, the architecture can support a wide variety of digital interfaces for connecting the base station mothers and the remotes, for example, T1/E1, or higher, like T3/E3 lines, fiber optic links, wireless T1/E1, or higher, digital coaxial links, such as cable modem interfaces, standard telephone cables, and DSL lines to name a few. While the discussion which follows will be principally in terms of T1 lines as the presently preferred connection, it will be recognized that other connections can be made depending on the costs and benefits for a particular environment and application. For example, if the base station mother or a remote mother is in a building, existing telephone cables can be used to connect the remotes to the mother. However, an analysis of the falling costs of T1 lines and the rising costs of towers and the decreasing availability of suitable locations for macrocell base transceiver stations demonstrates a simple and compelling case for the rapidly improving cost effectiveness of the techniques of the present invention.

A more complete understanding of the present invention, as well as further features and advantages of the invention, will be apparent from the following Detailed Description and the accompanying drawings.

### BRIEF DESCRIPTION OF THE DRAWINGS

FIG. 1 is a block diagram illustrating a conventional prior art macrocell communication network design;

FIG. 2 shows a master base transceiver station comprising a base station kernel operating in conjunction with a base station mother to control a plurality of stripped down, low power, low cost base station remotes in accordance with the present invention;

FIG. 3 illustrates further details of a base station remote in accordance with the present invention;

FIG. 4 illustrates an exemplary clustering arrangement utilizing a master base transceiver station with a plurality of base station mothers controlling clusters of remotes in accordance with the present invention.

### DETAILED DESCRIPTION

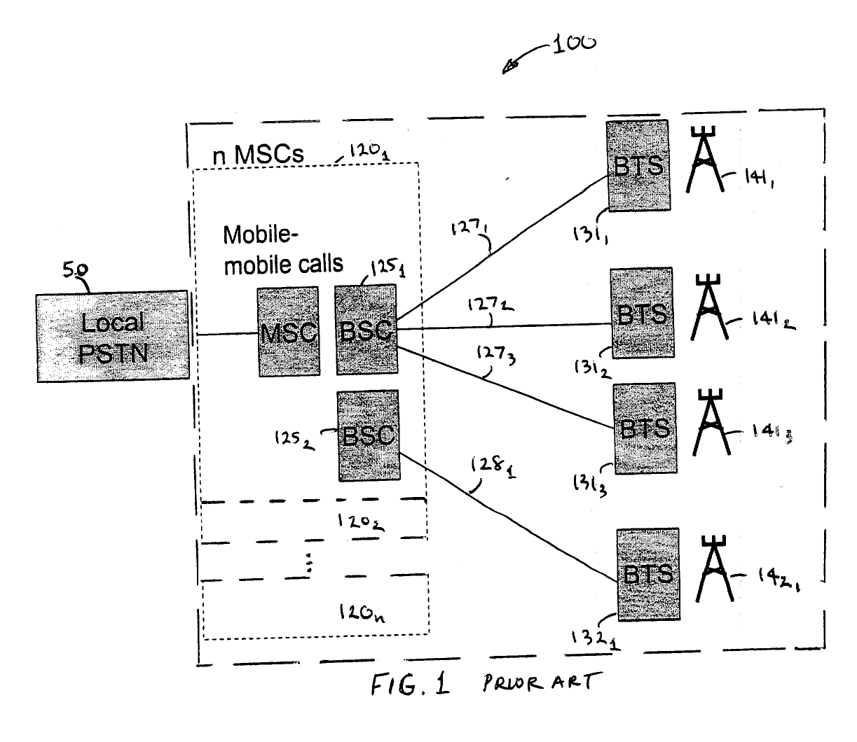

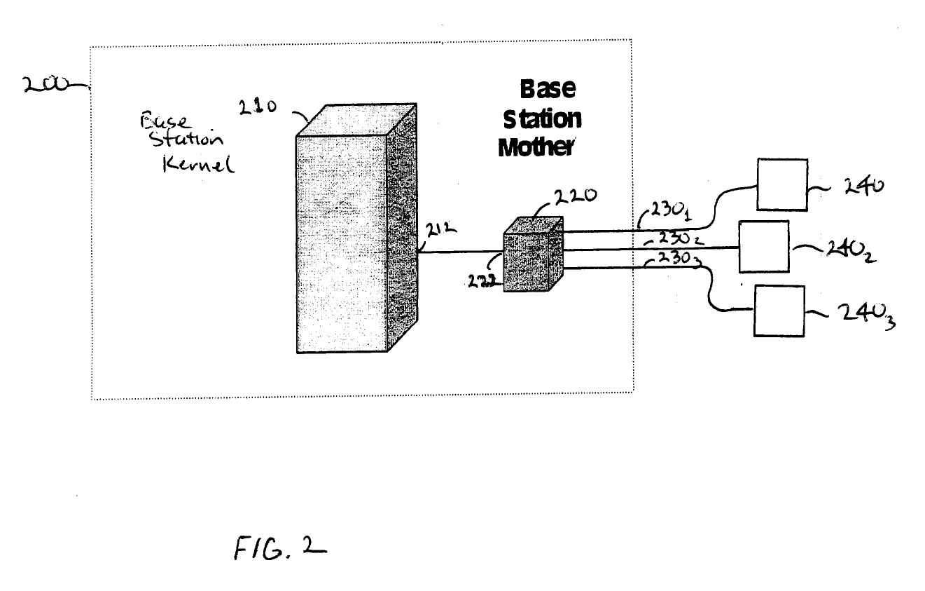

FIG. 2 illustrates various aspects of a master base transceiver station (MBTS) 200 in accordance with the present invention. As shown in FIG. 2, a prior art BTS such as the BTS₁₃₁, of FIG. 1 previously including full digital logic and control functionality, and collocated with an associated tower 141₁ or the like and connected by a wire connection such as the T1 line 131, to its base station controller 125, has been advantageously redefined and redesigned in accordance with the present invention as described below.

As seen in FIG. 2, the prior art BTS has been redesigned to separate the bulk of its logical functions into the MBTS 200 which comprises a base station kernel 210 and a base station mother 220. The rf functional components have been maintained in relatively low cost, small size base station remotes, with three such remotes 240₁, 240₂ and 240₃ shown in FIG. 2. These remotes are connected to base station mother 220 by T1 lines, 230₁, 230₂ and 230₃, respectively. It will be recognized that while only three remotes are shown for ease of illustration that the number of remotes, n, can be any desired number. While T1 lines are shown as presently preferred, it will be recognized that the link between the remotes and the base station can be based on circuit switched connections, like T1, or Internet protocol (IP) based, such as the Internet.

For a GSM embodiment, the base station kernel 220 will combine the logical functions for software layer 2, layer 3 and part of layer 1 and produces at an output 212 connected to an input 222 of the base station mother 220 a baseband output signal. The base station mother 220 will include interface circuitry for broadcasting the baseband output signal from the base station kernel 220 to the respective T1 lines 230₁, 230₂, and 230₃ on the downlink path to the remotes 240₁, 240₂, and 240₃. In the uplink path, base station mother 220 will include appropriate receive circuitry to combine the multiple signals from the remotes, to select the signal from the cell in which a mobile is located, or the like.

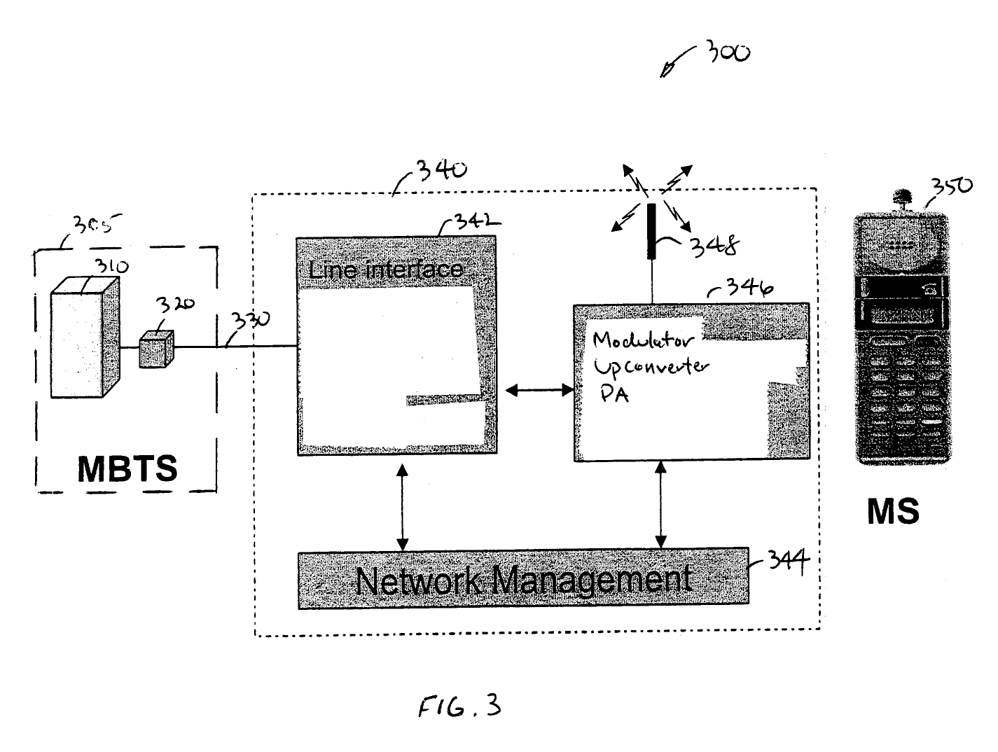

FIG. 3 illustrates a network 300 including an MBTS 305 including a base station kernel 310 and base station mother 320. MTBS 305 is connected by a T1 line 330 to a base station remote 340 which transmits to mobile stations such as cell phone 350. FIG. 3 shows further details of the base station remote 340 which as shown in FIG. 3 includes appropriate line interface circuitry 342 for connecting to the T1 line 330, network management software 344 and GSM frequency support transmission circuitry 346 for supporting 1 . . . x channels as desired for a particular application, and rf transmit and receive antennas 348 to wirelessly communicate with mobiles, such as exemplary mobile 350, in the area of coverage of the remote 340.

Exemplary functions to be provided by the network management software are device configuration with respect to the frequencies of transmission, output power and the like, alarm handling, for example, when a transmitter overheats, a synthesizer is out of lock or the like, performance management including monitoring the load of the remote, average output power and the like, and authorization and security functions, such as username, passwords, encryption and the like. Part of the circuitry 346 operates as a modulator to up convert the signals to be transmitted to the antennas 348. Circuitry 346 receives as an input a baseband signal and connects it to an rf output. It may suitably include a modulator, upconverter, power amplifier (PA), receiver, downconverter, and a demodulator; however, these components and functions are exemplary and the support transmission circuitry 346 may be variously implemented. While a T1 interface is specifically addressed, it will be recognized that appropriate interfaces for E1, DSL, optical, telephone wires, and wireless T1/E1 connections may be included as desired.

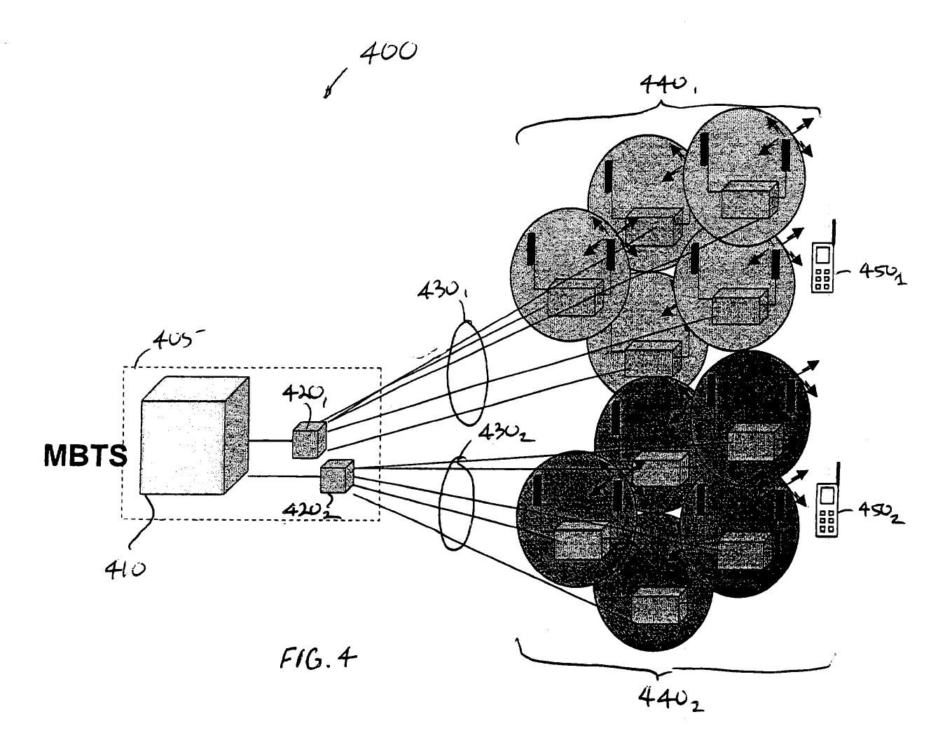

FIG. 4 illustrates a network 400 in which an MBTS 405 including a base station kernel 410 and two base station mothers 420₁ and 420₂ provides control signals using two sets 430₁ and 430₂ of five leased T1 lines to clusters 440₁ and 440₂ of remote stations. Each cluster represents a cell. The remote stations each comprise five individual stations transmitting at the same frequency to mobiles in their coverage area, such as mobiles 450₁ and 450₂, respectively. All of the remotes in cluster 440₁ are transmitting at a first frequency, f₁, and all of the remotes in cluster 440₂ are transmitting at a second frequency, f₂.

While five base station remotes are shown in each cluster, it will be recognized that N base station remotes may be employed in a cell area with a call being transmitted throughout that cell area. Similarly, while MBTS 405 is shown as having two base station mothers 420₁ and 4202₂, each controlling a cell area, it will be recognized that M base station mothers can be employed to serve M cell areas. A particular advantage of the present approach is that with appropriate circuitry to handle line delay the MBTS 405 can be located anywhere. Various clustering techniques can advantageously be employed as known in the art.

Additionally, it is presently preferred that in a simulcast environment that the base station mother includes suitable software and hardware to determine which data received from a plurality of remote stations should be used. In other words, if eight remotes are transmitting and a mobile's transmission is only being fully received by one remote, the circuitry will realize seven are received compromised transmissions and one is receiving the full transmission and act accordingly. Alternatively, if a mobile is in an area overlapped by two remotes, so that the mother is receiving some signal from both, the mother can combine the two signals. Thus, the mother can have both selective and combining modes of operation. Also, in a presently preferred embodiment suitable hardware and software will be included in a network with a large number of remotes to control the simulcasting of these remotes in clusters and allowing the simple reconfiguration of the clusters as desired to address the changing needs of the network. As indicated above, for example, a network with 10 clusters of 10 remotes may be reconfigured in a highly advantageous way to form a new network with 11 clusters, 10 with 9 remotes and 1 with 10 remotes, without adding additional remotes. Thus, by reducing the cluster size, cells can be added without the need for new additional sites to be added, unlike conventional approaches. Advantageously, a network can be rolled out with one time setup for an originally desired coverage plan. Then, it can be simply reconfigured to meet additional capacity demand.

While the present invention is disclosed in the context of a presently preferred embodiment, it will be recognized that a wide variety of implementations may be employed by persons of ordinary skill in the art consistent with the above discussion and the claims which follow below.

We claim:

1. A base station, where antenna and digital functions of a base station are separated, the base station comprising:
a master base transceiver station (MBTS); and
a separate base station remote including all radio frequency (rf) components.

2. The base station of claim 1 wherein the MBTS comprises:
a base station kernel; and
a base station mother.

3. The base station of claim 2 wherein the base station interface mother comprises an interface for receiving either an encoded/decoded baseband signal from the MBTS, or baseband data before encoding/decoding; and
wherein the base station is utilized in a duplex communication system and supports duplex communication.

4. The base station of claim 1 wherein its architecture can be used in GSM, CDMA, WiFi, or UMTS systems.

5. The base station of claim 1 wherein its architecture supports any digital interfaces, like: telephone wires, Ti/El lines (or higher), fiber optical links, wireless T1/E1 (or higher), digital coax links (like cable modem interfaces), or DSL lines to connect the MBTS and the separate base station remote.

6. The base station of claim 1 wherein the MBTS and the separate base station remote are connected by an Internet protocol (EP) based connection.

7. The base station mother of claim 2 wherein the base station mother can have 1 to N output ports supporting one cell where N represents the number of remotes connected to the base station mother.

8. The base station mother of claim 2 wherein the base station is further operable to make a decision, which data from a plurality of base station remotes to use in a simulcast environment.

9. The base station of claim 2 wherein the base station mother is further operable to make a decision, which data is sent to which base station remote of a plurality of base station remotes.

10. The base station of claim 1, wherein the separate base station remote is mounted on an existing telephone pole and is connected to the MBTS by an existing phone line.

11. A wireless communication network employing at least one base station having antenna and digital functions which are separated, the at least one base station comprising:
a master base transceiver station (MBTS); and
a separate base station remote including all radio frequency components.

12. A wireless communication network comprising:
a first plurality of m clusters of simulcasting base station remotes per cluster which communicate with a master base station (MBTS) by a wireline connection; and
a controller for causing the plurality of clusters to be reconfigured as a second plurality of m+1 simulcasting clusters.

13. A method of wireless communication comprising the steps of:
performing digital call processing in a base station kernel;
providing a processed digital signal from the base station kernel to a base station mother which conditions the processed signal and transmits it on a T1 line to a base station remote which does all the radio frequency (rf) signal processing; and
transmitting an rf signal with the base station remote.

14. The method of claim 13 wherein the signal conditioned by the base station mother is transmitted on a plurality of T1 lines to a plurality of clustered base station remotes.

15. A method of reconfiguring a wireless communication system comprising the steps of:
setting up an original network having a plurality of clusters or remotes of a given size to support an originally desired coverage plan; and
reconfiguring the original network by reducing the size of the plurality of clusters to meet additional capacity demand.
